(19) United States
(12) Patent Application Publication
(10) Pub. No.: US 2026/0307975 A1
(43) Pub. Date: Oct. 8, 2026

(54) SYSTEM AND METHOD FOR AUTOMATED FLUID DISPENSING WITH ADAPTIVE LEVEL DETECTION AND CONTROL

(71) Applicant: Pentair, Inc., Golden Valley, MN (US)

(72) Inventors: Ajit Tulo, Greater Noida (IN); Deepak Nirankari, Noida (IN); Alok Saxena, Noida (IN); Rushil Soni, New Delhi (IN); Parneet Singh Bedi, Greater Noida West (IN)

(21) Appl. No.: 19/642,030

(22) Filed: Apr. 8, 2026

Related U.S. Application Data
(60) Provisional application No. 63/785,303, filed on Apr. 8, 2025.

(51) Int. Cl. B67D 1/12; B67D 1/08

(52) U.S. Cl. CPC B67D 1/1238; B67D 1/0888; B67D 1/1236; B67D 2001/1263

(57) ABSTRACT

A fluid dispenser includes a first sensor, a second sensor, and a processor. The processor is configured to determine a brim height of a vessel based on data from the first sensor, determine a target fill level based on the brim height, determine a fluid level inside the vessel based on data from the second sensor, and dispense fluid into the vessel until the fluid level reaches the target fill level.

### CROSS-REFERENCE TO RELATED APPLICATIONS

This application claims priority to U.S. Provisional Patent Application No. 63/785,303 filed Apr. 8, 2025, the entire disclosure of which is incorporated by reference herein.

### BACKGROUND

Fluid dispensers are often used to dispense fluid (e.g., water, oil, etc.) from a larger fluid supply into smaller, often portable, containers (e.g., hand-held bottles). These fluid dispensers include a controllable valve to start and stop fluid flow from the fluid dispenser into the container. In some cases, the valve is electronically controlled based on a flow volume output, a combined weight of the container plus the dispensed fluid, an elapsed time, etc. In other cases, the valve is manually controlled, and filling of the container is monitored by a user. Consequently, conventional fluid dispensers are not configured to automatically dispense a volume of fluid into differing container shapes and volumes having differing starting fill levels.

### SUMMARY

In one independent aspect, a fluid dispenser may include a first sensor directed horizontally, a second sensor directed vertically, and a processor. The processor is configured to determine a brim height of a vessel based on data from the first sensor, determine a target fill level based on the brim height, determine a fluid level inside the vessel based on data from the second sensor, and dispense fluid into the vessel until the fluid level reaches the target fill level.

In some aspects, the first sensor is supported in a vertical post of a frame, and the second sensor is supported in a horizontal bridge of the frame. The second sensor may be positioned above the vessel. The second sensor may be positioned proximate to a fluid outlet of the fluid dispenser. The processor may be supported in a hollow frame of the fluid dispenser. The processor may be in communication with one or more of a valve and a pump to control dispensing of the fluid. The second sensor may be positioned to sense downwardly from the horizontal bridge. In some instances, the vertical distance is related to the fluid level.

In some aspects, a centering fixture may align the vessel below the second sensor. The centering fixture may include a plurality of vessel-centering actuators, each of the vessel-centering actuators is configured to urge the vessel to align with a vertical axis extending through the second sensor. The centering fixture may define a vessel cavity configured to receive the vessel.

In some aspects, the second sensor may be housed in a sensor housing extending downwardly from a horizontal bridge portion of a frame. The second sensor may define a horizontal datum relative to the vessel. The target fill level may be below the brim height, and the target fill level may be distanced from the brim height by a predetermined offset value. In some forms, the fluid dispenser includes a third sensor directed horizontally and positioned below the first sensor, and the processor is configured to determine the brim height of the vessel based on data from the first sensor and the third sensor. The first sensor may include a laser emitter opposite a laser detector.

In one independent aspect, a fluid dispenser may include a frame, a base, a fluid level sensor, a fluid outlet, a horizontal detection sensor, and a processor. The frame includes a bridge portion and a post. The base connects to the post. The fluid level sensor is supported by the bridge portion. The fluid outlet is supported by the bridge portion proximate to the fluid level sensor. The horizontal detection sensor is supported by the post. The processor is configured to cause the fluid dispenser to fill a vessel with a fluid dispensed from the fluid outlet to a target fluid level of the vessel based on data from the fluid level sensor and the horizontal detection sensor.

In some aspects, the processor may be configured to determine a brim height of the vessel based on data from the horizontal detection sensor, and the target fluid level is further from the fluid level sensor than the brim height. The processor may be configured to determine an actual fluid level of the fluid in the vessel based on data from the fluid level sensor, and to stop dispensing the fluid when the actual fluid level reaches the target fluid level.

In one independent aspect, a method of filling a vessel with a fluid includes placing the vessel into a fluid dispenser, determining a brim height of the vessel with a first sensor, determining an actual fluid level of fluid within the vessel with a second sensor, determining a target fill level based on the brim height and a predetermined offset value, and dispensing the fluid into the vessel until the actual fluid level reaches the target fill level.

In some aspects, placing the vessel in the fluid dispenser includes aligning the vessel relative to the second sensor with a vessel-centering fixture.

In overview of the present teaching, this disclosure provides a contactless fluid dispenser that eliminates the need for manual monitoring of liquid dispensing into containers having differing sizes and/or differing amounts of fluid already contained in the container at the beginning of fluid dispensing. In some instances, the fluid dispenser may be used in water dispensers at public and private outlets, industrial liquid dispensing, dispensing systems at laboratories, etc.

The fluid dispenser utilizes a top-mounted fluid level sensor (e.g., a time-of-flight (TOF) multizone ranging sensor, LiDAR module, etc.) to monitor a liquid level inside a vessel (e.g., a bottle) and at least one side-mounted height detection sensor (e.g., another TOF multizone ranging sensor, LiDAR module, etc.) to determine a height of the vessel. In some instances, the top-mounted fluid level sensor also includes or interfaces with a camera module. In some instances, a lower surface of the fluid level sensor serves as a datum for the fluid level sensor, the height detection sensor, and the vessel with respect to liquid dispensing measurements. These measurements include a height of the vessel, a target fill level, and a current fluid level in the vessel. For example, when viewed from the datum, the target fill level will be a greater distance from the datum than a distance of the brim of the vessel from the datum if filling is needed. As a further example, when viewed from the datum, the current fill level will be a distance that is greater than or equal to a distance of the target fill level from the datum.

The fluid dispenser further includes a self-centering fixture that adapts to differing container types, diameters, shapes, etc. Additionally, the fluid dispenser is operatively compatible with differing container materials (e.g., glass, metal, plastic, composite, etc.) and differing container transparency levels (e.g., opaque, translucent, transparent, etc.). In some instances, the fluid dispenser is operatively compatible with vessel materials and finishes that are at least partially reflective.

The fluid dispenser includes electronic components to control vessel filling. In some instances, these electronic components include a primary controller, the fluid level sensor, one or more height detection sensors, a first relay, and a second relay. In some forms, the electronic components also include an intermediate controller. More specifically, the primary controller performs overall control of the fluid dispenser. The fluid level sensor detects the current fill level inside the vessel. The height detection sensors aid in calculating the bottle height (e.g., a distance from the datum (bottom of fluid level sensor) to the brim of the vessel). The intermediate controller can act as a bridge between the height detection sensor, the fluid level sensor, and the primary controller by performing pre-processing of the data from the one or both of the height detection sensor and the fill level sensor. The first relay can control the pump, and the second relay can control the solenoid valve during the dispense cycle.

Further, when one or both of the height detection sensor(s) or the fill level sensor is provided in the form of a TOF multizone ranging sensor, the respective sensor is configured to send a data grid formed of multiple columns (e.g., eight) and multiple rows (e.g., eight) of data, (e.g., 64 data cells) to one of the intermediate controller or the primary controller. With respect to the height detection sensor, the data grid includes the statuses of a grouped subset of neighboring columns (e.g., columns numbered four and five of eight) projected onto the vessel, which contain data used to determine the distance from the vessel brim to the fluid level sensor. Thus, in the reduced data grid (e.g., the grouped subset of eight rows by two columns (8×2)), the cells of each row are coupled together to form merged cells that each have a two-digit row value (e.g., [00], [11], [01], [10]). Hence, the two-dimensional (e.g., column and row) reduced data grid may be viewed as and/or further reduced into a one-dimensional data array.

More specifically, a merged data cell is referred to as inactive when the height detection sensor does not detect an object in any of the unmerged data cells from which the merged data cell is formed, the vessel is too far from the height detection sensor, and/or the height detection sensor has lost signal. A merged data cell is referred to as active when the height detection sensor detects an object in at least one of the unmerged data cells from which the merged data cell is formed.

Further, to determine the distance from the brim of the vessel to the fluid level sensor based on data received from an intermediate controller (or the fluid level sensor directly), the merged data cells may be parsed, marked as “active” or “inactive”, and stored in a one-dimensional data array (e.g., 1×8) in the same sequence as received. Thus, the first occurrence of a row with an active merged data cell may be determined from the data array and looked up in a lookup table and/or database to determine a corresponding physical distance value from the brim to the fluid level sensor.

Additionally, in some instances, the fluid dispenser utilizes a laser emitter and detector pairs arranged in a grid to determine the height of the vessel and a TOF laser sensor to monitor the liquid level inside the vessel.

Overall, various features of the fluid dispenser work together to provide adaptable, touchless, and spill-reducing fluid dispensing.

### BRIEF DESCRIPTION OF THE DRAWINGS

The accompanying drawings, which are incorporated in and form a part of this specification, illustrate embodiments of the disclosure and, together with the description, serve to explain the principles of embodiments of the disclosure:

FIG. 1 is a front view of a fluid dispenser, according to an embodiment, filling a vessel;

FIG. 2 is a rear isometric view of the fluid dispenser of FIG. 1;

FIG. 3 is a bottom plan view of the fluid dispenser of FIG. 1;

FIG. 4 is a top plan view of the fluid dispenser of FIG. 1 with a top cover removed;

FIG. 5 is a left-side elevational view of the fluid dispenser of FIG. 1 with a first side cover removed;

FIG. 6 is a right-side elevational view of the fluid dispenser of FIG. 1 with a second side cover removed;

FIG. 7 is a cross-sectional view of the fluid dispenser of FIG. 1 taken along line A-A of FIG. 3;

FIG. 8 is a block diagram of various electronic components of the fluid dispenser of FIG. 1;

FIG. 9 is a schematic view of a fluid level sensor and height detection sensors of the fluid dispenser of FIG. 1 sensing the vessel of FIG. 1;

FIG. 10 is a mounting arrangement of the fluid level sensor and height detection sensors of FIG. 9;

FIG. 11 is a grid map of the height detection sensors of FIG. 9 projected onto the vessel of FIG. 1;

FIG. 12 is a height detection results table based on signals from the height detection sensors of FIG. 9;

FIG. 13 is a height detection results data string based on signals from the height detection sensors of FIG. 9;

FIG. 14 is a look-up table to determine a distance between the fluid level sensor of FIG. 9 and a brim of the vessel of FIG. 1;

FIG. 15 is a first portion of a flow diagram depicting a method of filling the vessel of FIG. 1 using the fluid dispenser of FIG. 1, according to the principles of this disclosure;

FIG. 16 is a second portion of the flow diagram of FIG. 15;

FIG. 17 is a front view of a fluid dispenser according to an embodiment, filling a vessel;

FIG. 18 is a top plan view of the fluid dispenser of FIG. 17 with a top cover removed;

FIG. 19 is a block diagram of various electronic components of the fluid dispenser of FIG. 17;

FIG. 20 is a schematic view of a fluid level sensor and height detection sensors of the fluid dispenser of FIG. 17 sensing the vessel of FIG. 17;

FIG. 21 is a grid map of the fluid level sensor of FIG. 20 projected onto the vessel of FIG. 17;

FIG. 22 is a front view of a fluid dispenser according to an embodiment, filling a vessel;

FIG. 23 is a block diagram of various electronic components of the fluid dispenser of FIG. 22;

FIG. 24 is a schematic view of a fluid level sensor and height detection sensors of the fluid dispenser of FIG. 22 sensing the vessel of FIG. 22;

FIG. 25 is a first portion of a flow diagram depicting a method to fill the vessel of FIG. 22 using the fluid dispenser of FIG. 22, according to the principles of this disclosure; and

FIG. 26 is a second portion of the flow diagram of FIG. 25.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize that the examples provided herein have many useful alternatives and fall within the scope of embodiments of the invention. The invention is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings, but can also refer to communicative, electrical, or fluidic couplings.

As used herein, unless otherwise specified or limited, “at least one of A, B, and C,” and similar other phrases, are meant to indicate A, or B, or C, or any combination of A, B, and/or C. As such, this phrase, and similar other phrases, can include single or multiple instances of A, B, and/or C, and, in the case that any of A, B, and/or C indicates a category of elements, single or multiple instances of any of the elements of the categories A, B, and/or C.

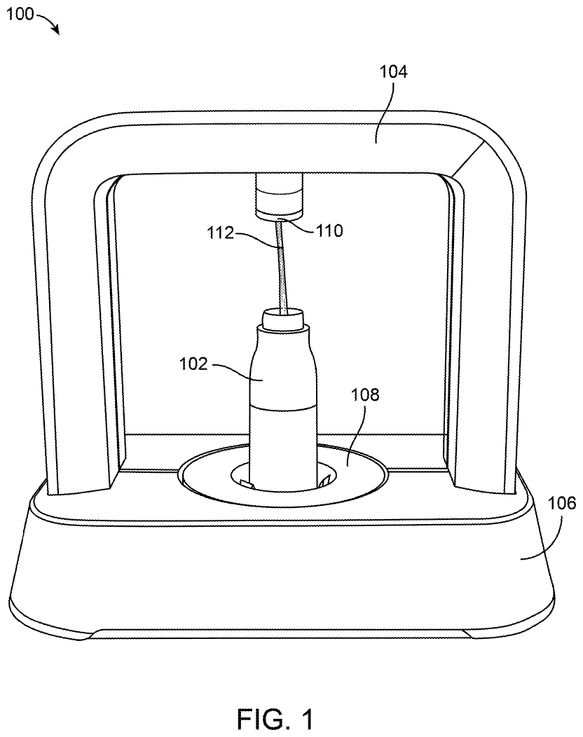

Referring generally to FIG. 1, a fluid dispenser 100 according to the disclosure is illustrated. The fluid dispenser 100 is configured to receive a vessel 102 between a frame 104 and a base 106. More specifically, a vessel-centering fixture 108 supported by the base 106 receives and aligns the vessel 102 relative to a fluid outlet 110. Although the vessel 102 is depicted in FIG. 1 as being generally cylindrical, the fluid dispenser 100 is adaptable to fill vessels of differing shapes, volumes, and sizes that fit into the vessel-centering fixture 108 and within the frame 104. When the vessel 102 is properly aligned beneath the fluid outlet 110, the fluid dispenser 100 dispenses fluid 112 (e.g., water) into the vessel 102. As the fluid 112 dispenses, the fluid dispenser 100 monitors a fluid level inside the vessel 102 and stops dispensing the fluid 112 before the vessel 102 overflows, as will be explained in greater detail below.

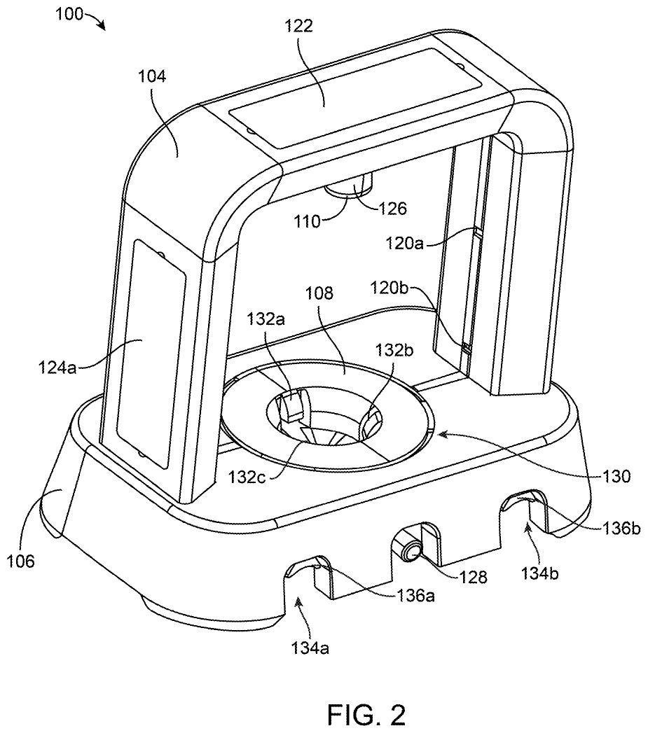

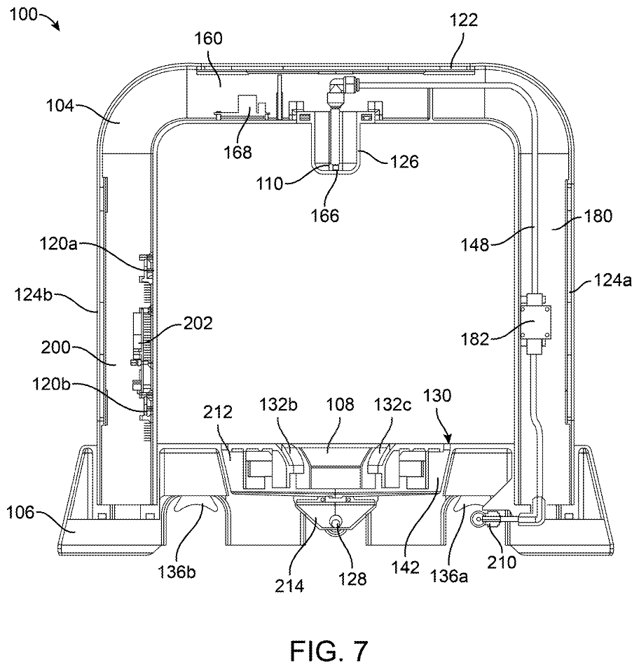

With reference to FIG. 2, the frame 104 is connected to a base 106. The frame 104 supports the fluid outlet 110, a first horizontal detection sensor 120a, and a second horizontal detection sensor 120b. In some embodiments, the first and second horizontal detection sensors 120a, 120b are TOF multizone ranging sensors. A top cover 122, a first side cover 124a, and a second side cover 124b (shown in FIG. 7) are removably mounted to the frame 104. More specifically, the fluid outlet 110 extends through a sensor housing 126, which extends downwardly from the frame 104 toward the base 106. Additionally, the base 106 supports a drain 128 and defines a vessel cavity 130 into which the vessel-centering fixture 108 is fitted.

Although the fluid dispenser 100 is depicted in FIG. 1 as including both the first and second horizontal detection sensors 120a, 120b, it should be understood that, in some instances, the fluid dispenser 100 may have only the first horizontal detection sensor 120a. Further, in some instances, the fluid dispenser 100 may include more horizontal detection sensors in addition to the first and second horizontal detection sensors 120a, 120b.

In operation, the vessel 102 (shown in FIG. 1) is inserted into the vessel-centering fixture 108. The vessel-centering fixture 108 is provided in the form of a collar and includes a plurality of vessel-centering actuators 132a-132c, which are engaged with the vessel-centering fixture 108 to provide linear or movable translation of the vessel-centering actuators 132a-132c with respect to the collar. The vessel-centering actuators 132a-132c are arranged radially symmetrically around the collar and each of the vessel-centering actuators 132a-132c is configured to provide a force on the vessel 102 that is directed radially inward in order to center the vessel 102 in the vessel cavity 130. In some instances, the vessel-centering actuators 132a-132c are spring-loaded such that each of the actuators 132a-132c provides a substantially similar force on the vessel 102 to center the vessel 102 in the vessel cavity 130. Thus, the vessel-centering actuators 132a-132c contact and push the vessel 102 to align the vessel 102 substantially directly below the fluid outlet 110 when the vessel 102 is inserted into the vessel-centering fixture 108. Additionally, the vessel-centering fixture 108 and the vessel-centering actuators 132a-132c can be at least partially beveled to facilitate insertion of the vessel 102 into the base 106. The drain 128 is in fluid communication with the vessel cavity 130 such that spills caught in the vessel cavity 130 gravitationally drain out of the vessel cavity 130 via the drain 128. In some forms, the fluid dispenser 100 may be attached to a support structure (not shown) via cutouts 134a, 134b and dovetail pins 136a, 136b.

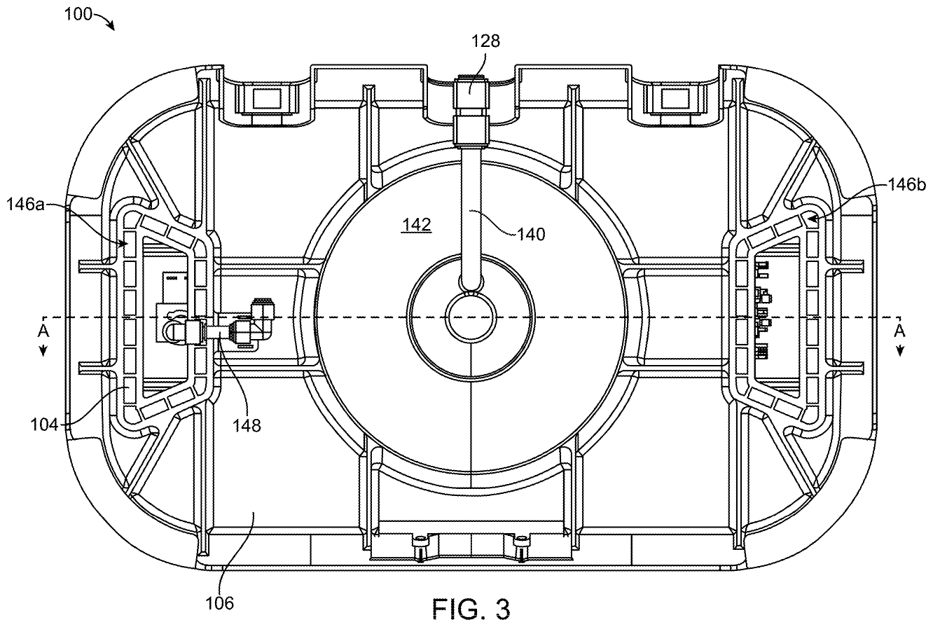

With reference to FIG. 3, a drain line 140 fluidly connects the drain 128 to the vessel cavity 130 (shown in FIG. 2), which is defined by a basin 142 formed in the base 106. The frame 104 engages the base 106 via a first plurality of resilient clips 146a and a second plurality of resilient clips 146b. Additionally, the frame 104 and the base 106 support a fluid supply line 148.

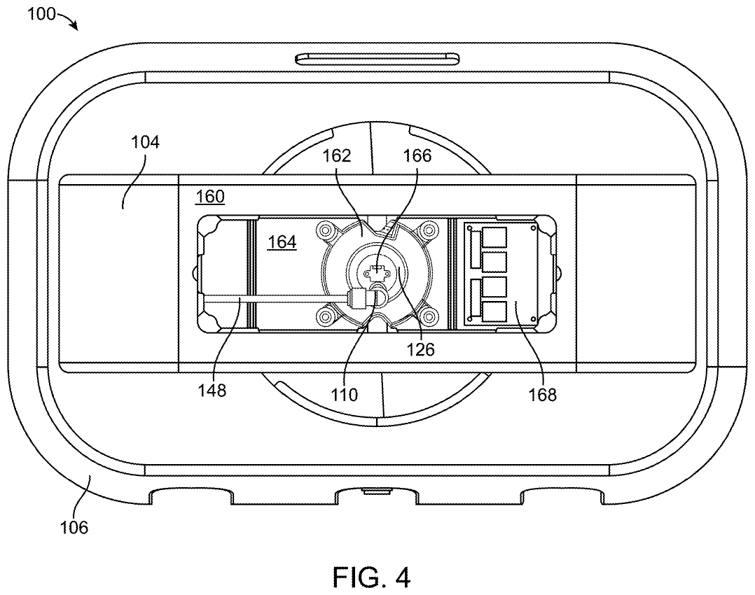

Referring to FIG. 4, the sensor housing 126 extends through and is supported by a bridge portion 160 of the frame 104. More specifically, a radially outwardly extending flange 162 of the sensor housing 126 mounts to an inner surface 164 of the bridge portion 160. A fluid level sensor 166 is fixed to and supported by the sensor housing 126. Further, the fluid supply line 148 extends through the sensor housing 126 to provide fluid communication with the fluid outlet 110. The bridge portion 160 further supports a relay board 168. Here, the bridge portion 160 is hollow, and the fluid supply line 148 and the relay board 168 are disposed within the bridge portion 160.

The fluid level sensor 166 is arranged in the sensor housing 126 directly proximate to the fluid outlet 110. In this way, the fluid level sensor 166 is configured to sense a fluid level in the vessel 102 that is placed into the vessel-centering fixture 108 below the sensor housing 126. Thus, the fluid level sensor 166 senses (e.g., “looks”) downwardly. In some embodiments, the fluid level sensor 166 is a TOF LiDAR ranging sensor. In some embodiments, the fluid level sensor 166 is a TOF multizone ranging sensor like the first and second horizontal detection sensors 120a, 120b.

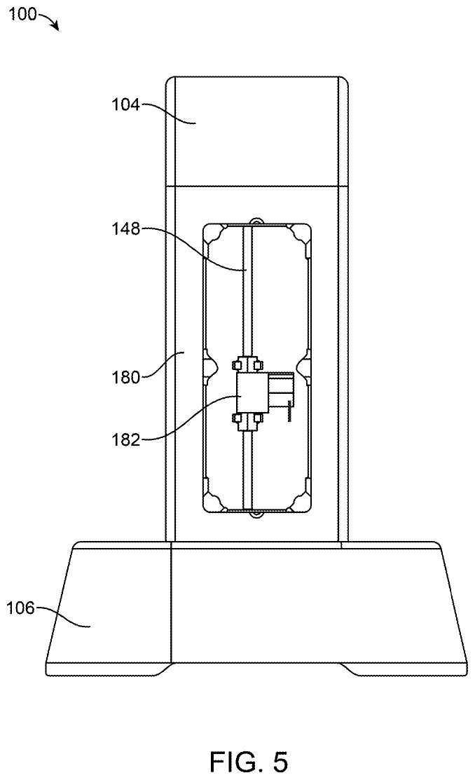

With reference to FIG. 5, a first post 180 of the frame 104 supports a solenoid valve 182, which is positioned along and controls fluid flow through the fluid supply line 148. More specifically, the first post 180 is hollow, and the fluid supply line 148 and the solenoid valve 182 are disposed within the first post 180.

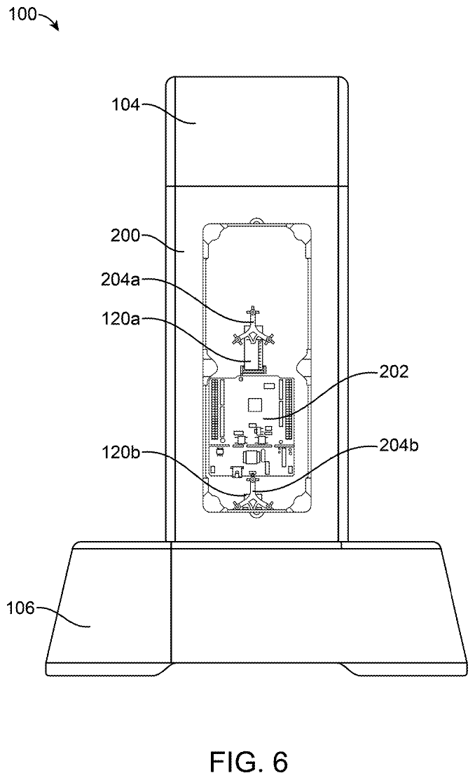

With reference to FIG. 6, a second post 200 of the frame 104 supports the first and second horizontal detection sensors 120a, 120b and a control board 202. In some embodiments, first and second clips 204a, 204b retain the first and second horizontal detection sensors 120a, 120b in the second post 200, respectively. Thus, the first and second horizontal detection sensors 120a, 120b are directed horizontally toward the first post 180 to sense aspects of the vessel 102 when it is positioned between the first post 180 and the second post 200. In some embodiments, the first and second clips 204a, 204b are three-legged and/or radially symmetrical. Here, the second post 200 is also hollow, and the first and second horizontal detection sensors 120a, 120b and the control board 202 are disposed within the second post 200.

With reference to FIG. 7, the fluid supply line 148 runs through and is supported by the frame 104, which is hollow. Additionally, the fluid supply line 148 fluidly connects to a fluid supply inlet 210, which is supported by the base 106. The first side cover 124a is removable and shields the solenoid valve 182. Also, the second side cover 124b is removable and shields the first and second horizontal detection sensors 120a, 120b and the control board 202. The top cover 122 removably shields the fluid level sensor 166, the fluid outlet 110, and the relay board 168. Additionally, the basin 142 includes an upper frustoconical portion 212 and a lower frustoconical portion 214, which collect fluid spills. The upper frustoconical portion 212 is larger than the lower frustoconical portion 214 and supports the vessel-centering fixture 108, which is removable from the upper frustoconical portion 212.

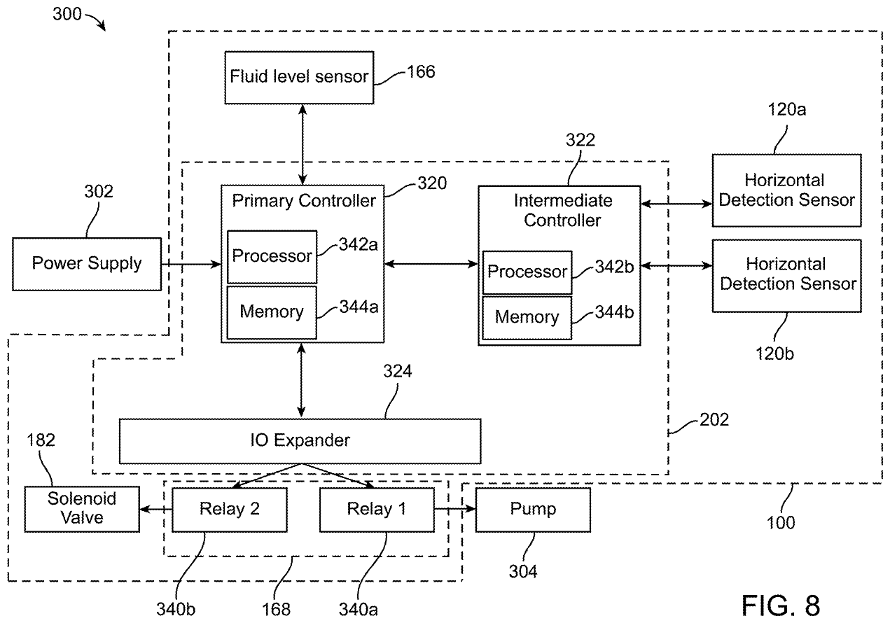

FIG. 8 illustrates various interconnected electronic components 300 of the fluid dispenser 100 itself and/or with which the fluid dispenser 100 is integrated. The electronic components 300 include the control board 202, which is electrically and/or communicatively coupled to a power supply 302, the first and second horizontal detection sensors 120a, 120b, the fluid level sensor 166, and the relay board 168. The electronic components 300 further include the solenoid valve 182 and a pump 304, which are electrically coupled to the relay board 168.

In some instances, the control board 202 includes a primary controller 320 that is electrically and/or communicatively coupled to an intermediate controller 322, an I/O expander 324, the fluid level sensor 166, and the power supply 302. In some instances, the intermediate controller 322 is in communication with the first and second horizontal detection sensors 120a, 120b. In some embodiments, the fluid level sensor 166 is electrically and/or communicatively coupled to the intermediate controller 322 rather than the primary controller 320. In some forms, the primary controller 320 and the intermediate controller 322 are provided as a single, integrated controller.

Further, in some instances, the relay board 168 is electrically and/or communicatively coupled to the I/O expander 324. More specifically, the relay board 168 includes first and second relays 340a, 340b, which are in communication with the solenoid valve 182 and the pump 304, respectively.

The primary controller 320 and the intermediate controller 322 include the first and second processors 342a, 342b and the first and second memories 344a, 344b, respectively. The processors 342a, 342b of the controllers 320, 322 may be provided in the form of one or more of any suitable processing devices or set of processing devices, such as, but not limited to a microprocessor, a microcontroller-based platform, a suitable integrated circuit, one or more field-programmable gate arrays (FPGAs), and/or one or more application-specific integrated circuits (ASICs). The processors 342a, 342b are configured to execute non-transitory computer-readable instructions, such as instructions stored in the memories 344a, 344b.

In some forms, the processors 342a, 342b may be provided in the form of multiple processors or a single processor, the memories 344a, 344b may be provided in the form of multiple memories or a single memory, and the controllers 320, 322 may be provided in the form of multiple controllers or a single controller. One or more of the multiple processors may be coupled with one or more of the multiple memories, which may, individually or collectively, be configured to perform various functions described herein. In some examples, the processors 342a, 342b may be a component of a processing system, which may refer to a system (such as a series) of machines, circuitry (including, for example, one or both of processor circuitry (which may include the processors 342a, 342b), and memory circuitry (which may include the memories 344a, 344b)), or components that receive or obtain inputs and process the inputs to produce, generate, or obtain a set of outputs. The processing system may be configured to perform one or more of the functions described herein. For example, the processors 342a, 342b or a processing system including the processors 342a, 342b may be configured to, or configurable to, perform one or more of the functions described herein. Further, as described herein, being “configured to,” being “configurable to,” and being “operable to” may be used interchangeably and may be associated with a capability, when executing code (e.g., processor-executable code) stored in the memories 344a, 344b or otherwise, to perform one or more of the functions described herein.

The terms “non-transitory computer-readable medium” and “tangible computer-readable medium” should be understood to include a single medium or multiple media, such as a centralized or distributed database, and/or associated caches and servers that store one or more sets of instructions. The terms “non-transitory computer-readable medium” and “tangible computer-readable medium” also include any tangible medium that can store, encode, or carry a set of instructions for execution by the processors 342a, 342b or a processing system including the processors 342a, 342b to perform any one or more of the methods or operations disclosed herein. As used herein, the term “tangible computer-readable medium” includes any type of computer-readable storage device and/or storage disk and excludes propagating signals. As used herein, the terms “tangible computer-readable medium” and “tangible machine-readable medium” can be used interchangeably.

Here, the primary controller 320 determines a fluid level inside the vessel 102 based on data and/or signals from the fluid level sensor 166. The primary controller 320 also determines a height of the vessel 102 (e.g., a distance from the fluid level sensor 166 to the brim of the vessel 102) based on data and/or signals received from the intermediate controller 322, which are based on data and/or signals from the first and second horizontal detection sensors 120a, 120b. More specifically, in some instances, the intermediate controller 322 converts and/or reformats data from the first and second horizontal detection sensors 120a, 120b into data readable by the primary controller 320.

The primary controller 320 further controls the pump 304 via the I/O expander 324 and the first relay 340a. Similarly, the primary controller 320 also controls the solenoid valve 182 via the I/O expander 324 and the second relay 340b.

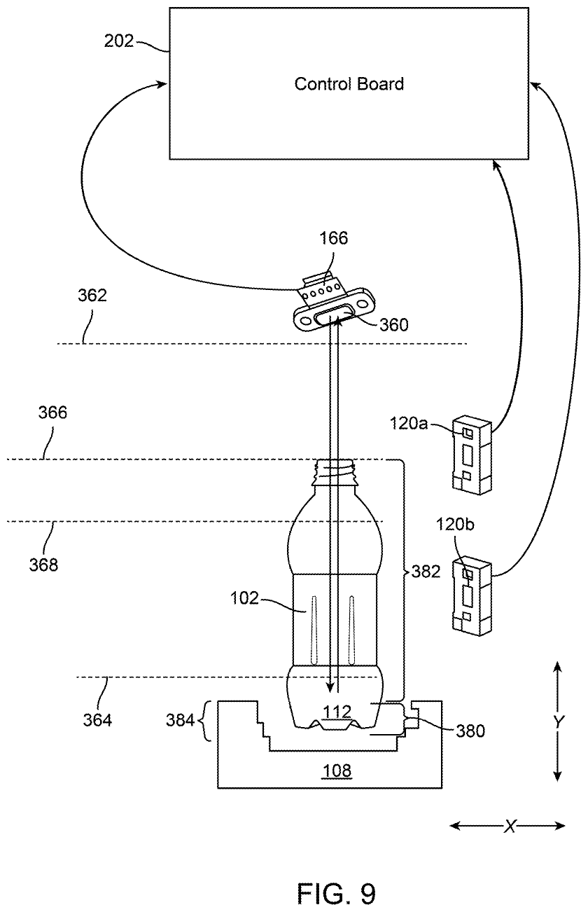

With reference to FIG. 9, a lower surface 360 of the fluid level sensor 166 and/or the sensor housing 126 (shown in FIG. 7) defines a datum 362 from which sensor measurements taken regarding the vessel 102 are relative. In operation, when the vessel 102 is placed in the vessel-centering fixture 108, the first and second horizontal detection sensors 120a, 120b detect the vessel 102 in a horizontal direction X and the fluid level sensor 166 detects the fluid 112 within the vessel 102 in a vertical direction Y.

The control board 202 determines an actual fluid level 364 of the fluid 112 within the vessel 102 relative to the datum 362 by way of one or both of the processors 342a, 342b based on data from the fluid level sensor 166. Further, the control board 202 determines a brim height 366 of the vessel 102 relative to the datum 362 by way of one or both of the processors 342a, 342b based on data from the first and second horizontal detection sensors 120a, 120b. Additionally, the control board 202 determines a target fluid level 368 of the vessel 102 relative to the datum 362 based on the brim height 366 by way of one or both of the processors 342a, 342b. In some instances, a predefined offset distance value stored in one or more of the first and second memories 344a, 344b is used to calculate the target fluid level 368. For example, a total vessel height can be calculated using a known distance from the bottom of the vessel-centering fixture 108 to the datum 362 and the brim height 366, e.g., the distance from the datum 362 to the brim of the vessel 102. Then, a percentage of the total vessel height, such as 15 to 20 percent, can be added to the brim height 366 to arrive at the target fluid level 368. It should be understood that, instead of being subtracted, this percentage is added to the brim height 366 because the fluid level sensor 166 senses (e.g., “looks”) downwardly from the datum 362. Thus, the target fluid level 368 is further from the datum 362 than the brim height 366, e.g., the target fluid level 368 is below the brim height 366, so that the fluid dispenser 100 does not overfill the vessel 102.

Additionally, in operation, the control board 202 controls the solenoid valve 182 and/or pump 304 (shown in FIG. 8), by way of one or both of the processors 342a, 342b, to dispense the fluid 112 until the actual fluid level 364 reaches the target fluid level 368, at which point the control board 202 commands the solenoid valve 182 and/or pump 304 to stop dispensing the fluid 112 (e.g., close, turn off, etc.).

In some forms, when the vessel 102 is inserted into the vessel-centering fixture 108, a lower portion 380 of the vessel 102 is obscured while an upper portion 382 remains exposed. Thus, in some instances, the lower portion 380 is hidden from, and the upper portion 382 is detectable by, the first and second horizontal detection sensors 120a, 120b. Further, in some instances, one or more of the first and second memories 344a, 344b store a predetermined depth 384 of the vessel-centering fixture 108 to compensate for the hidden lower portion 380 when determining the total vessel height of the vessel 102.

Further, in instances where a user mistakenly inserts a capped and/or closed vessel into the vessel-centering fixture 108, the fluid level sensor 166 detects the closed vessel and the control board 202 prevents dispensing of the fluid 112. Similarly, where a user prematurely removes the vessel 102 from the vessel-centering fixture 108 before dispensing of the fluid 112 is complete, the first and/or second horizontal detection sensors 120a, 120b detect the early removal and the control board 202 stops dispensing the fluid 112.

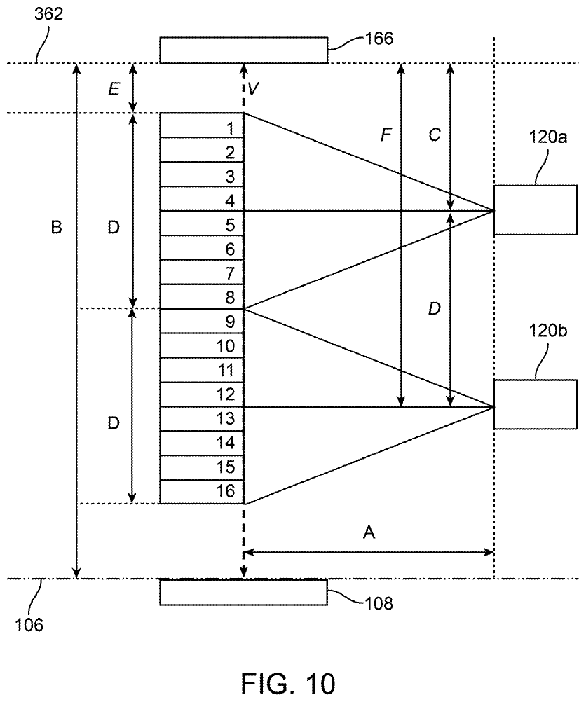

With reference to FIG. 10, the fluid level sensor 166 and the vessel-centering fixture 108 define a central vertical axis V, which is substantially perpendicular to the datum 362. The first and second horizontal detection sensors 120a, 120b are distanced from the central vertical axis V by a horizontal offset distance value A. In some forms, the horizontal offset distance value A is between about 175 mm and about 185 mm, or about 180 mm. In instances where the fluid dispenser 100 includes only the first horizontal detection sensor 120a, the horizontal offset distance value A is between about 180 mm and about 190 mm, or about 186 mm. Further, the fluid level sensor 166 is distanced from the vessel-centering fixture 108 and/or the base 106 by a first vertical offset distance value B. The first horizontal detection sensor 120a is distanced from the datum 362 by a second vertical offset C. In some forms, the second vertical offset C is between about 95 mm and about 105 mm, or about 100 mm. In instances where the fluid dispenser 100 includes only the first horizontal detection sensor 120a, the second vertical offset C is also between about 95 mm and about 105 mm, or about 100 mm, or in some instances, between about 310 mm and about 320 mm, or about 317 mm. In additional instances where the fluid dispenser 100 includes only the first horizontal detection sensor 120a, the second vertical offset C is between about 95 mm and about 105 mm, or about 100 mm, or in some instances, between about 310 mm and about 320 mm, or about 317 mm. Also, the second horizontal detection sensor 120b is distanced from the datum 362 by a third vertical offset distance value F. In some forms, the third vertical offset distance value F is between about 230 mm and about 245 mm, or about 238 mm.

Additionally, each of the first and second horizontal detection sensors 120a, 120b has a vertical detection range D along the central vertical axis V. In some forms, the vertical detection range D is between about 130 mm and about 145 mm, or about 138 mm. Moreover, the vertical detection range D of the first horizontal detection sensor 120a is distanced from the datum 362 by a fourth vertical offset E. Further, in some instances, the first and second horizontal detection sensors 120a, 120b are distanced from one another by the vertical detection range D.

The first horizontal detection sensor 120a senses a first plurality of equally spaced horizontal detection rows 1-8 along and/or substantially perpendicular to the central vertical axis V. Similarly, the second horizontal detection sensor 120b senses a second plurality of equally spaced horizontal detection rows 9-16 along the central vertical axis V. In some instances, the horizontal offset distance A is determined as a function of the resolution of the horizontal detection rows 1-16. More specifically, while permitting clearance of the vessel 102 within the frame 104 (shown in FIG. 1), the frame 104 may be arranged to place the first and second horizontal detection sensors 120a, 120b close to the central vertical axis V. Thus, the horizontal offset distance A is reduced, which increases (e.g., makes finer) the resolution of the horizontal detection rows 1-16. Further, as the resolution increases, height measurements of the vessel 102 become more accurate.

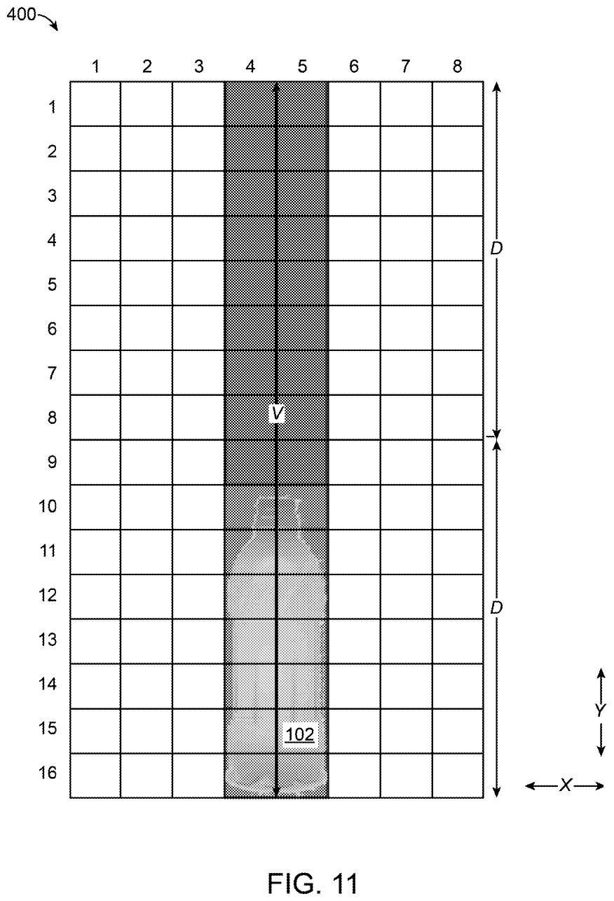

With reference to FIG. 11, the first and second horizontal detection sensors 120a, 120b (shown in FIG. 10) also sense a first plurality of equally spaced vertical detection columns 1-8 that are substantially parallel to the central vertical axis V. Thus, the horizontal detection rows 1-16 and the vertical detection columns 1-8 form a grid of detection cells 400. In instances where the fluid dispenser 100 includes only the first horizontal detection sensor 120a, the fluid dispenser 100 will only have 1-8 horizontal detection rows. In some instances, the central vertical axis V runs between vertical detection columns 4 and 5. Thus, in some instances, when the vessel 102 is seated in the vessel-centering fixture 108 (shown in FIG. 9), the detection data from vertical detection columns 4 and 5 is the optimal data for determining the brim height 366 because the highest point of the vessel 102 will be detected along the center of the vessel 102 where the drinking spout is typically located. In some forms, more, fewer, or different columns than columns 4 and 5 are used to determine the brim height 366.

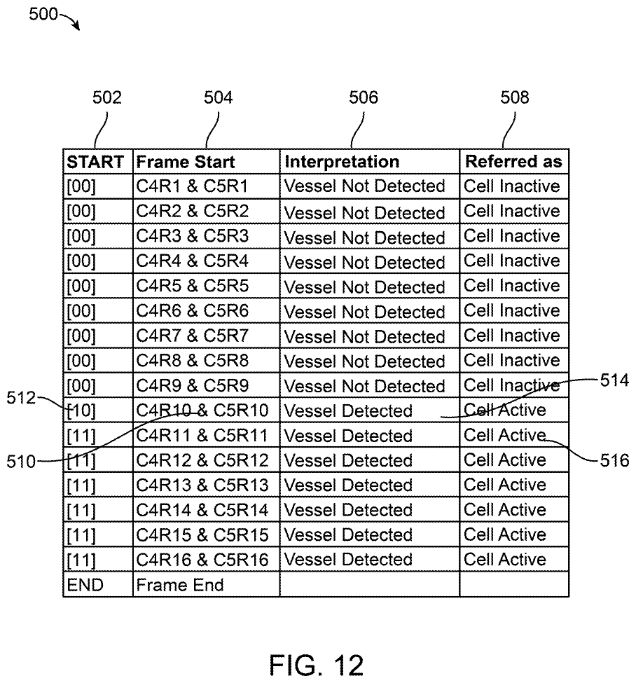

With reference to FIG. 12, the control board 202 (shown in FIG. 8) develops a detection results table 500 via one or both of the processors 342a, 342b based on which individual cells of the grid of detection cells 400 align with the vessel 102 (as shown in FIG. 11). The detection results table 500 includes a binary results column 502, a cell grouping column 504, an interpretation column 506, and an activation column 508.

The cell grouping column 504 assembles cells together by row from neighboring columns of the grid of detection cells 400 into cell groups 510. For example, the cell grouping column 504 groups together the cells from columns 4 and 5 of row 10 of the grid of detection cells 400 into the cell group 510 labeled “C4R10 & C5R10” (e.g., column 4 row 10 & column 5 row 10).

Further, the binary results column 502 lists binary values 512 for each cell group 510. Each binary value 512 assigns a binary digit (i.e., 0 or 1) to each of the constituent cells within the cell groups 510 based on whether the vessel 102 was detected in the respective cells of the grid of detection cells 400. More specifically, the digit “1” indicates that the vessel 102 was detected in the respective cell of the grid of detection cells 400. Conversely, the digit “0” indicates that the vessel 102 was not detected in the respective cell of the grid of detection cells 400.

Additionally, the interpretation column 506 lists vessel detection results 514 for each cell group 510. More specifically, if the binary value 512 of a cell group 510 includes a “1” digit, the interpretation column 506 indicates that the vessel 102 (shown in FIG. 11) was detected (e.g., “vessel detected”) as the vessel detection result 514 for that cell group 510. Conversely, if the binary value 512 of a cell group 510 does not include any “1” digits (i.e., includes exclusively “0” digits), the interpretation column 506 indicates that the vessel 102 (shown in FIG. 11) was not detected (e.g., “vessel not detected”) as the vessel detection result 514 for that cell group 510.

Further, the activation column 508 lists cell activation results 516 for each cell group 510. More specifically, if the binary value 512 of a cell group 510 includes a “1” digit, the activation column 508 indicates that one or more of the constituent cells of that cell group 510 was activated (e.g., “cell active”) as the cell activation result 516 for that cell group 510. Conversely, if the binary value 512 of a cell group 510 does not include any “1” digits (i.e., includes exclusively “0” digits), the activation column 508 indicates that none of the constituent cells of that cell group 510 was activated (e.g., “cell inactive”) as the cell activation result 516 for that cell group 510.

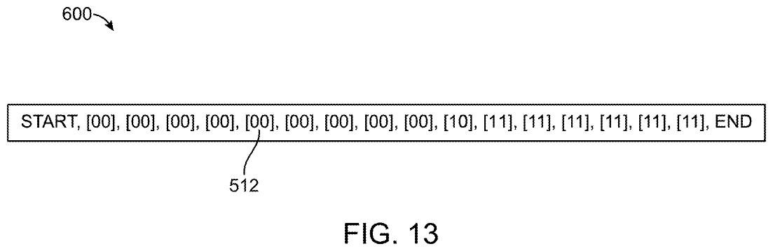

With reference to FIG. 13, in some instances, the control board 202 (shown in FIG. 8) compiles the binary values 512 from the detection results table 500 (shown in FIG. 12) into a data string 600 via one or both of the processors 342a, 342b. Thus, the two-dimensional and/or graphical detection results from the grid of detection cells 400 (shown in FIG. 10) may be reduced to the one-dimensional numerical data string 600 for simplified processing and/or storage by the processors 342a, 342b and/or the first and second memories 344a, 344b of the control board 202.

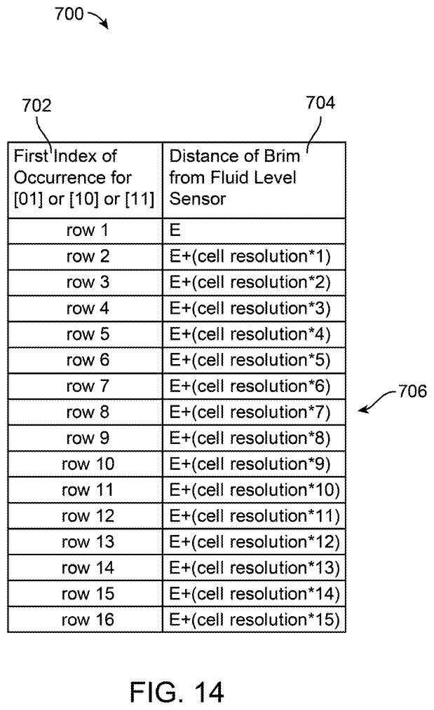

With reference to FIG. 14, in some instances, a brim height look-up table 700 is stored in one or more of the first and second memories 344a, 344b (shown in FIG. 8). The brim height look-up table 700 includes a first-occurrence column 702, which correlates the row position of the first occurrence of a non-zero (e.g., [01], [10], [11], etc.) binary value 512 (shown in FIG. 12) with a formula column 704, which lists brim height formulas 706 for each row 1-16 of the grid of detection cells 400 (shown in FIG. 10). Thus, the control board 202 (shown in FIG. 8) may determine the brim height 366 of the vessel 102 (shown in FIG. 9) based on the uppermost detection row 1-16 in which the vessel is detected, the fourth vertical offset E (shown in FIG. 10), and a resolution (e.g., height) of each of the detection rows 1-16. The resolution may be stored in one or more of the first and second memories 344a, 344b. In some forms, the cell resolution is between about 18 mm and about 19 mm, or about 18.6 m and about 19 mm, or about 18.6 mm. In instances where the fluid dispenser 100 includes only the first horizontal detection sensor 120a, the cell resolution is between about 19 mm and about 20 mm, or about 19.25 mm.

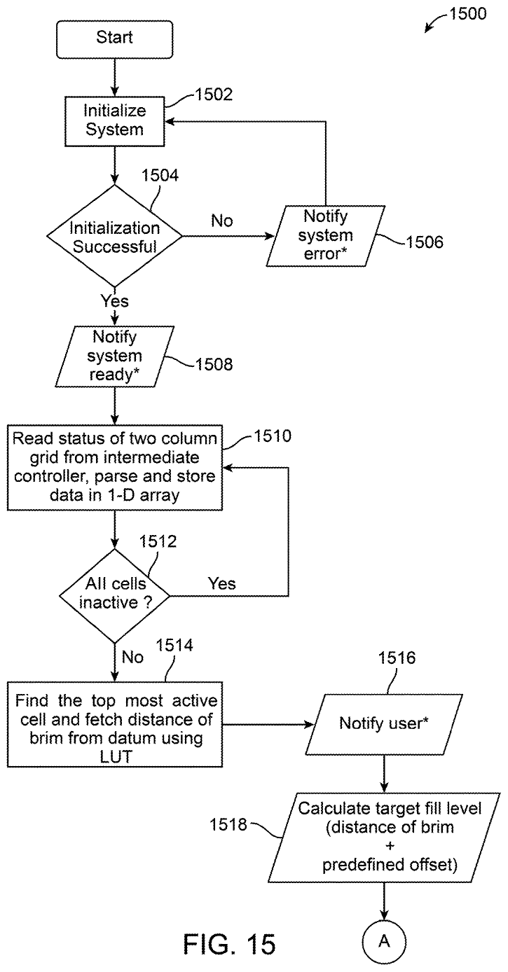

FIG. 15 illustrates a first portion of a flow diagram depicting a method 1500 executable by one or both of the processors 342a, 342b of the control board 202 (shown in FIG. 8) to dispense fluids using the fluid dispenser 100 of FIG. 1. The method 1500 starts at step 1502, where the electronic components 300 initialize and establish communications with one another. More specifically, the primary controller 320 and the intermediate controller 322 turn on via the power supply 302 and establish communications with one another. Further, the primary controller 320 establishes communications with the fluid level sensor 166 and, via the relay board 168 and the I/O expander 324, the solenoid valve 182 and the pump 304. Additionally, the intermediate controller 322 establishes communications with the first and second horizontal detection sensors 120a, 120b. Moreover, one or more of the first and second memories 344a, 344b receives or populates the brim height look-up table 700. The method 1500 proceeds to step 1504.

At step 1504, the control board 202 determines whether initialization was successful.

If, at step 1504, the control board 202 determines that initialization was not successful, the method proceeds to step 1506.

If, at step 1504, the control board 202 determines that initialization was successful, the method 1500 proceeds to step 1508.

At step 1506, the control board 202 notifies a user of the initialization failure (e.g., via a display, illuminated lamp, sound, etc.). In some forms, step 1506 is omitted. The method 1500 returns to step 1502.

At step 1508, the control board 202 notifies the user of the initialization success (e.g., via a display, illuminated lamp, sound, etc.). In some forms, step 1508 is omitted. The method 1500 proceeds to step 1510.

At step 1510, the primary controller 320 reads data from the intermediate controller 322 for a status of all cells of the two-column grid overlaying the vessel 102 (see e.g., columns 4 and 5 of FIG. 11). The primary controller 320 further parses and stores the cell statuses one-dimensionally as the data string 600. The method 1500 proceeds to step 1512.

At step 1512, the control board 202 determines whether all the cells of the two-column grid are inactive, i.e., there is no vessel 102 in the fluid dispenser 100.

If, at step 1512, the control board 202 determines that not all the cells of the two-column grid are inactive, the method 1500 proceeds to step 1514.

If, at step 1512, the control board 202 determines that all the cells of the two-column grid are inactive, the method 1500 returns to step 1510.

At step 1514, the control board 202 finds the top-most active cell and, using the brim height look-up table 700, determines the brim height 366 of the vessel 102 relative to the datum 362. More specifically, the primary controller 320 finds the index of the topmost active cell by referring to the data string 600. The method 1500 proceeds to step 1516.

At step 1516, the control board 202 notifies the user of the brim height 366 (e.g., via a display, illuminated lamp, sound, etc.). In some forms, step 1516 is omitted. The method 1500 proceeds to step 1518.

At step 1518, the control board 202 calculates the target fluid level 368. More specifically, the control board 202 adds the predefined offset distance value to the brim height 366 to calculate the target fluid level 368. The method 1500 proceeds to linking node A.

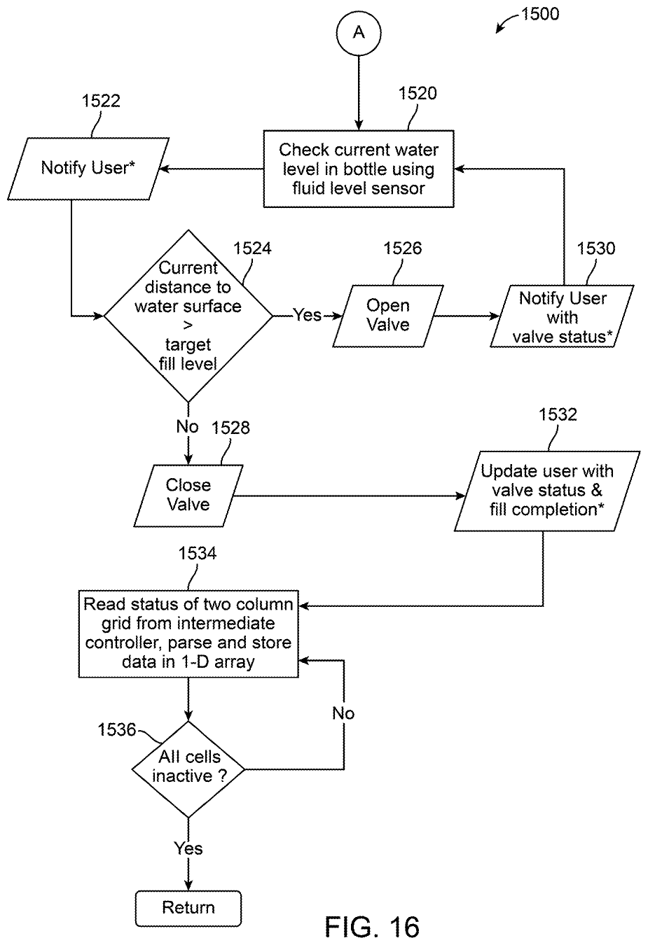

FIG. 16 illustrates a second portion of the flow diagram depicting the method 1500 executable by one or both of the processors 342a, 342b of the control board 202 (shown in FIG. 8) to dispense the fluid 112 using the fluid dispenser 100 of FIG. 1. From linking node A, the method 1500 proceeds to step 1520, where the primary controller 320 checks the actual fluid level 364 using the fluid level sensor 166. In some instances, one or both of the processors 342a, 342b average a plurality of samples (e.g., ten samples) to determine the actual fluid level 364. The method 1500 proceeds to step 1522.

At step 1522, the control board 202 notifies the user of the actual fluid level 364 (e.g., via a display, illuminated lamp, sound, etc.). In some forms, step 1522 is omitted. The method 1500 proceeds to step 1524.

At step 1524, the control board 202 determines whether the actual fluid level 364 is greater than the target fluid level 368 with respect to the datum 362.

If, at step 1524, the control board 202 determines that the actual fluid level 364 is greater than the target fluid level 368 with respect to the datum 362, the method 1500 proceeds to step 1526.

If, at step 1524, the control board 202 determines that the actual fluid level 364 is not greater than the target fluid level 368 with respect to the datum 362, the method 1500 proceeds to step 1528.

At step 1526, the control board 202 opens the solenoid valve 182 and/or initiates the pump 304. The method 1500 proceeds to step 1530.

At step 1530, the control board 202 notifies the user of a status (e.g., open, closed, etc.) of the solenoid valve 182 (e.g., via a display, illuminated lamp, sound, etc.). In some forms, step 1530 is omitted. The method 1500 returns to step 1520.

At step 1528, the control board 202 closes the solenoid valve 182 and/or deactivates the pump 304. The method 1500 proceeds to step 1532.

At step 1532, the control board 202 notifies the user of the status of the solenoid valve 182 and that the vessel 102 is full (e.g., via a display, illuminated lamp, sound, etc.). In some forms, step 1532 is omitted. The method 1500 proceeds to step 1534.

At step 1534, the primary controller 320 reads data from the intermediate controller 322 for a status of all cells of the two-column grid overlaying the vessel 102. The primary controller 320 further parses and stores the cell statuses one-dimensionally as the data string 600. The method 1500 proceeds to step 1536.

At step 1536, the control board 202 determines whether all the cells of the two-column grid are inactive.

If, at step 1536, the control board 202 determines that not all the cells of the two-column grid are inactive (signifying that the vessel 102 has not been removed), the method 1500 returns to step 1534.

If, at step 1536, the control board 202 determines that all the cells of the two-column grid are inactive (signifying removal of the vessel 102), the method 1500 returns to step 1502.

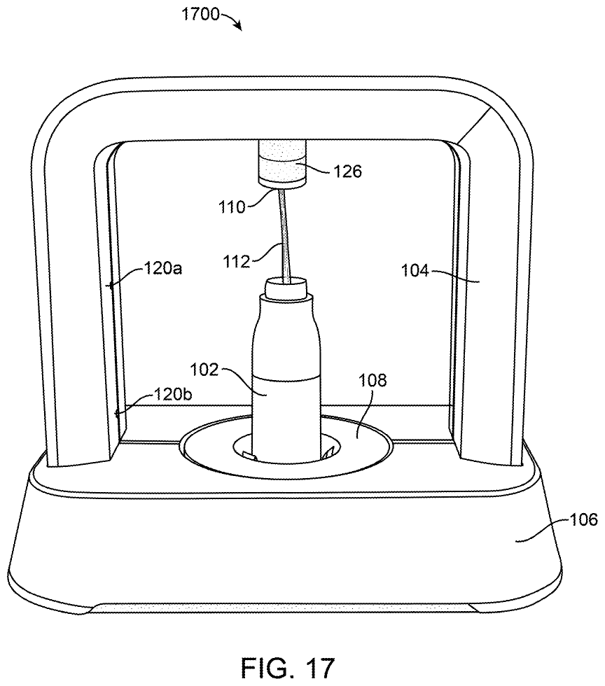

Referring generally to FIG. 17, a fluid dispenser 1700 according to the disclosure is illustrated. The fluid dispenser 1700 is similar to the fluid dispenser 100 of FIG. 1, but includes some differing internal components, as will be explained in greater detail below. The fluid dispenser 1700 includes the frame 104, the base 106, the vessel-centering fixture 108, and the fluid outlet 110. The fluid dispenser 1700 is configured to receive the vessel 102 between the frame 104 and the base 106 and dispense the fluid 112 into the vessel 102. Although the vessel 102 is depicted in FIG. 17 as being generally cylindrical, the fluid dispenser 1700 is adaptable to fill vessels of differing shapes, volumes, and sizes that fit into the vessel-centering fixture 108 and within the frame 104. As the fluid 112 dispenses, the fluid dispenser 1700 monitors the fluid level inside the vessel 102 and stops dispensing the fluid 112 before the vessel 102 overflows.

The fluid dispenser 1700 includes the first horizontal detection sensor (HDS) 120a, the second horizontal detection sensor 120b, the covers 122, 124a, 124b, the sensor housing 126, the drain 128, the drain line 140, and the fluid supply line 148 supported by the frame 104 and/or the base 106 in the same manner as described above with respect to the fluid dispenser 100 of FIG. 1.

Although the fluid dispenser 1700 is depicted in FIG. 17 as including both the first and second horizontal detection sensors 120a, 120b, it should be understood that, in some instances, the fluid dispenser 1700 may have only the first horizontal detection sensor 120a. Further, in some instances, the fluid dispenser 1700 may include more horizontal detection sensors in addition to the first and second horizontal detection sensors 120a, 120b.

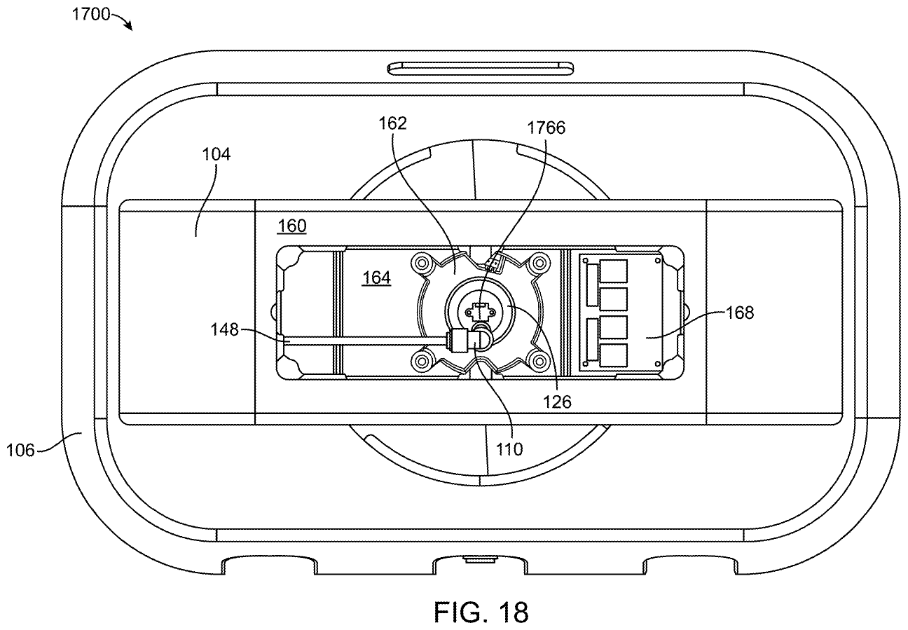

Referring to FIG. 18, the fluid dispenser 1700 includes a fluid level sensor 1766 supported in the sensor housing 126 directly proximate to the fluid outlet 110. In this way, the fluid level sensor 1766 is configured to sense a fluid level in the vessel 102 (shown in FIG. 17) that is placed in the base 106 below the sensor housing 126. Thus, the fluid level sensor 1766 senses (e.g., “looks”) downwardly. In some embodiments, the fluid level sensor 1766 is a TOF multizone ranging sensor. Thus, in some embodiments, the fluid level sensor 1766 is the same sensor type and/or substantially identical to the sensor type of the first and second horizontal detection sensors 120a, 120b.

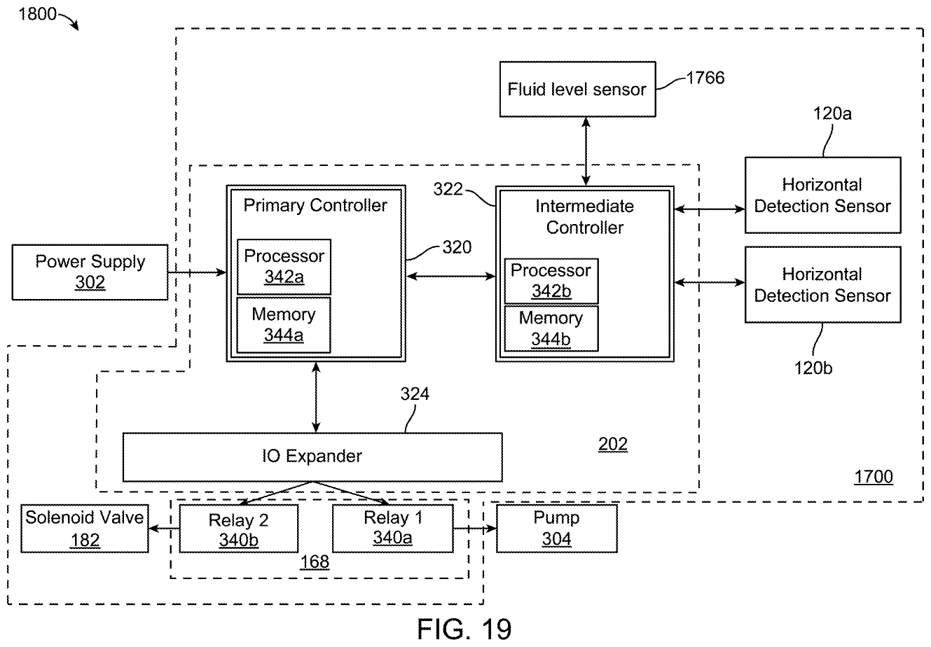

FIG. 19 illustrates various interconnected electronic components 1800 of the fluid dispenser 1700 itself and/or with which the fluid dispenser 1700 is integrated. The electronic components 1800 include the control board 202, which is electrically and/or communicatively coupled to the power supply 302, the first and second horizontal detection sensors 120a, 120b, the fluid level sensor 1766, and the relay board 168. The electronic components 1800 further include the solenoid valve 182 and the pump 304, which are electrically coupled to the relay board 168.

In some instances, the fluid level sensor 1766 is electrically and/or communicatively coupled to the primary controller 320. In some embodiments, the fluid level sensor 1766 is electrically and/or communicatively coupled to the intermediate controller 322 rather than the primary controller 320. In some forms, the primary controller 320 and the intermediate controller 322 are provided as a single, integrated controller.

The primary controller 320 determines a fluid level inside the vessel 102 (shown in FIG. 17) based on data and/or signals received from the fluid level sensor 1766 via the intermediate controller 322. The primary controller 320 also determines a height of the vessel 102 (e.g., a distance from the fluid level sensor 1766 to the brim of the vessel 102) based on data and/or signals received from the intermediate controller 322, which are based on data and/or signals from the first and second horizontal detection sensors 120a, 120b. More specifically, in some instances, the intermediate controller 322 converts and/or reformats data from the first and second horizontal detection sensors 120a, 120b and the fluid level sensor 1766 into data readable by the primary controller 320.

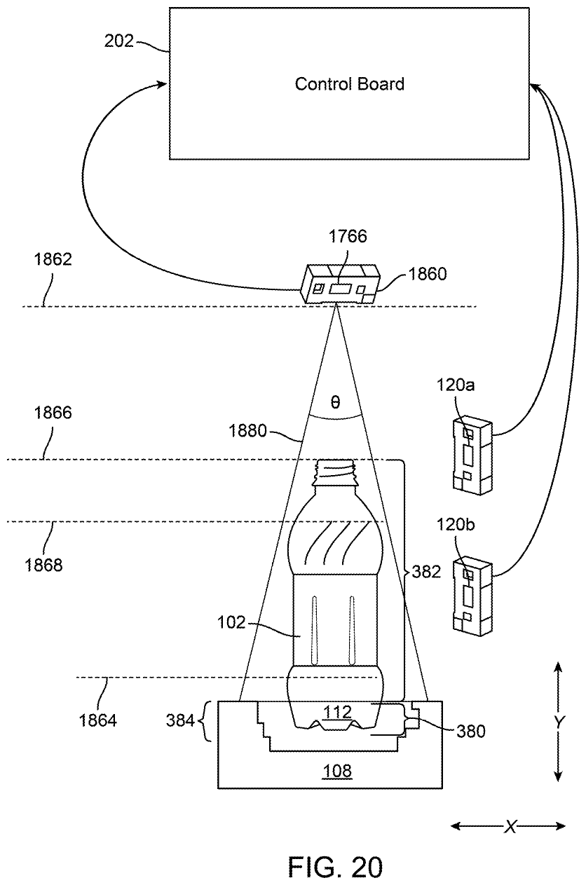

With reference to FIG. 20, a lower surface 1860 of the fluid level sensor 1766 and/or the sensor housing 126 (shown in FIG. 17) defines a datum 1862 from which sensor measurements taken regarding the vessel 102 are relative. In operation, when the vessel 102 is placed in the vessel-centering fixture 108, the first and second horizontal detection sensors 120a, 120b detect the vessel 102 in the horizontal direction X and the fluid level sensor 1766 detects the fluid 112 within the vessel 102 in the vertical direction Y. The fluid level sensor 1766 has a detection cone 1880, within which the vessel 102 is detectable by the fluid level sensor 1766. The detection cone 1880 defines a sensing angle θ.

The control board 202 determines an actual fluid level 1864 of the fluid 112 within the vessel 102 relative to the datum 1862 by way of one or both of the processors 342a, 342b based on data from the fluid level sensor 1766. Further, the control board 202 determines a brim height 1866 of the vessel 102 relative to the datum 1862 by way of one or both of the processors 342a, 342b based on data from the first and second horizontal detection sensors 120a, 120b. Additionally, the control board 202 determines a target fluid level 1868 of the vessel 102 relative to the datum 1862 based on the brim height 1866 by way of one or both of the processors 342a, 342b. In some instances, a predefined offset distance value stored in one or more of the first and second memories 344a, 344b is used to calculate the target fluid level 1868. For example, a total vessel height can be calculated using a known distance from the bottom of the vessel-centering fixture 108 to the datum 1862 and the brim height 1866, e.g., the distance from the datum 1862 to the brim of the vessel 102. Then, a percentage of the total vessel height, such as 15 to 20 percent, can be added to the brim height 1866 to arrive at the target fluid level 1868. It should be understood that, instead of being subtracted, this percentage is added to the brim height 1866 because the fluid level sensor 1766 senses (e.g., “looks”) downwardly. Thus, the target fluid level 1868 is further from the datum 1862 than the brim height 1866, e.g., the target fluid level 1868 is below the brim height 1866, so that the fluid dispenser 1700 does not overfill the vessel 102.

Additionally, in operation, the control board 202 controls the solenoid valve 182 and/or pump 304 (shown in FIG. 19), by way of one or both of the processors 342a, 342b, to dispense the fluid 112 until the actual fluid level 1864 reaches the target fluid level 1868, at which point the control board 202 commands the solenoid valve 182 and/or pump 304 to stop dispensing the fluid 112 (e.g., close, turn off, etc.).

As explained above with respect to the fluid dispenser 100, when the vessel 102 is inserted into the vessel-centering fixture 108, the lower portion 380 of the vessel 102 is obscured while the upper portion 382 remains exposed. Thus, in some instances, the lower portion 380 is hidden from, and the upper portion 382 is detectable by, the first and second horizontal detection sensors 120a, 120b. Further, in some instances, one or more of the first and second memories 344a, 344b store the predetermined depth 384 of the vessel-centering fixture 108 to compensate for the hidden lower portion 380 when determining the total vessel height of the vessel 102.

Further, in instances where a user mistakenly inserts a capped and/or closed vessel (not shown) into the vessel-centering fixture 108, the fluid level sensor 1766 detects the closed vessel and the control board 202 prevents dispensing of the fluid 112. Similarly, where a user prematurely removes the vessel 102 from the vessel-centering fixture 108 before dispensing of the fluid 112 is complete, the first and/or second horizontal detection sensors 120a, 120b detect the early removal and the control board 202 stops dispensing the fluid 112.

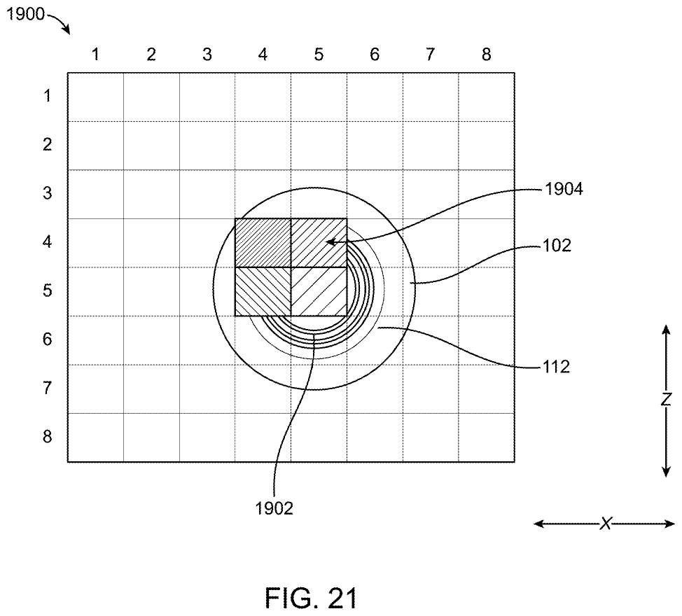

With reference to FIG. 21, the fluid level sensor 1766 (shown in FIG. 19) senses a plurality of equally spaced detection columns 1-8 in the horizontal direction X and a plurality of equally spaced detection rows 1-8 in a second horizontal direction Z. Thus, the detection columns 1-8 and rows 1-8 form a grid of detection cells 1900. In some instances, each of the detection cells 1900 represents a subset field of view angle (e.g., in a range from 4.5 to 6.5 degrees) of the sensing angle θ (shown in FIG. 20). More specifically, in some instances, the vessel 102 is substantially centered in the grid of detection cells 1900. Thus, in some instances, when seated in the vessel-centering fixture 108 (shown in FIG. 20), a brim 1902 of the vessel 102 aligns with a central grouping 1904 of detection cells 1900 along detection columns 4 and 5 and detection rows 4 and 5. More specifically, given a radially symmetrical (e.g., cylindrical) vessel 102, the vessel-centering fixture 108 is configured to align the brim 1902 within one cell of the central grouping 1904. The control board 202 (shown in FIG. 20) determines the actual fluid level 1864 of the fluid 112 within the vessel 102 relative to the datum 1862 based on signal strength measurements of cells in the central grouping 1904 from the fluid level sensor 1766.

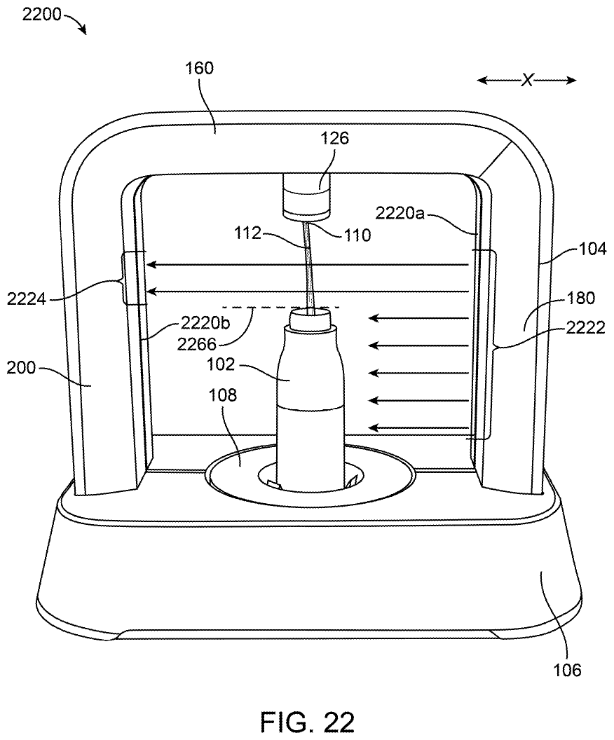

Referring generally to FIG. 22, a fluid dispenser 2200 according to the disclosure is illustrated. The fluid dispenser 2200 is similar to the fluid dispenser 100 of FIG. 1, but includes some differing internal components, as will be explained in greater detail below. The fluid dispenser 2200 includes the frame 104, the base 106, the vessel-centering fixture 108, and the fluid outlet 110. The fluid dispenser 2200 is configured to receive the vessel 102 between the frame 104 and the base 106 and dispense the fluid 112 into the vessel 102. Although the vessel 102 is depicted in FIG. 22 as being generally cylindrical, the fluid dispenser 2200 is adaptable to fill vessels of differing shapes, volumes, and sizes that fit into the vessel-centering fixture 108 and within the frame 104. As the fluid 112 dispenses, the fluid dispenser 2200 monitors the fluid level inside the vessel 102 and stops dispensing the fluid 112 before the vessel 102 overflows.

The fluid dispenser 2200 includes the covers 122, 124a, 124b, the sensor housing 126, the drain 128, the drain line 140, the fluid supply line 148, and the fluid level sensor 166, which are all fixed to, and supported by, the frame 104 and/or the base 106 in the same manner as in the fluid dispenser 100 of FIG. 1.

The fluid dispenser 2200 further includes a laser emitter bank 2220a and a laser detector bank 2220b, e.g., light-dependent resistors. The laser emitter bank 2220a and the laser detector bank 2220b are supported by the first post 180 and the second post 200 of the frame 104, respectively. Thus, the laser emitter bank 2220a is opposite the laser detector bank 2220b. More specifically, the laser emitter bank 2220a discharges a plurality of laser beams 2222 in a horizontal direction X toward the laser detector bank 2220b, which senses the laser beams 2222. In some instances, the laser beams 2222 are a color visible to the human eye. In some instances, the laser beams 2222 are invisible to the human eye (e.g., infrared, ultraviolet, etc.).

Additionally, when the vessel 102 is placed in the vessel-centering fixture 108, the vessel 102 blocks at least a portion of the plurality of laser beams 2222 from reaching the laser detector bank 2220b. Thus, the laser detector bank 2220b senses an unblocked subset 2224 of the laser beams 2222. Consequently, the fluid dispenser 2200 determines a brim height 2266 of the vessel 102 based on data from the laser detector bank 2220b indicating the unblocked subset 2224 of laser beams 2222.

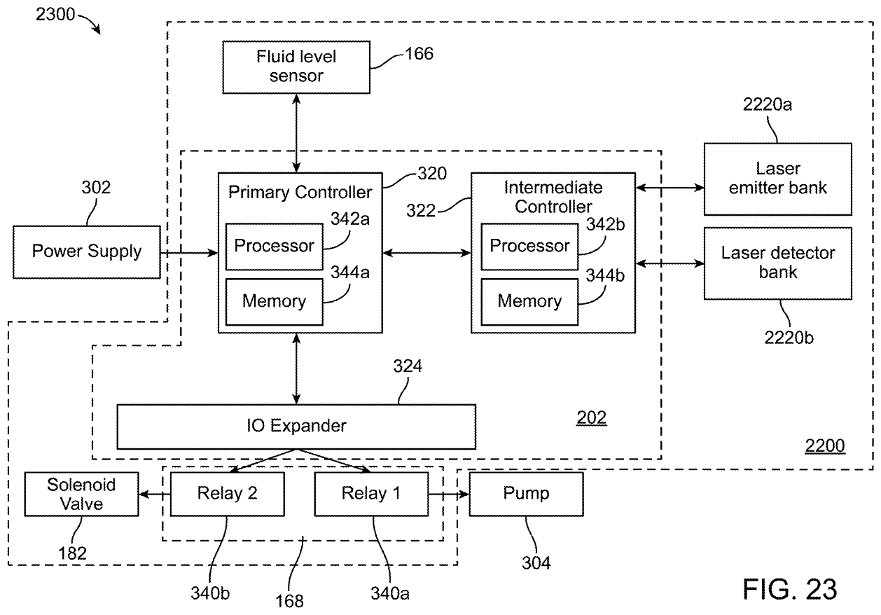

FIG. 23 illustrates various interconnected electronic components 2300 of the fluid dispenser 2200 itself and/or with which the fluid dispenser 2200 is integrated. The electronic components 2300 include the control board 202, which is electrically and/or communicatively coupled to the power supply 302, the laser emitter and detector banks 2220a, 2220b, the fluid level sensor 166, and the relay board 168. The electronic components 2300 further include the solenoid valve 182 and the pump 304, which are in communication with the relay board 168.

In some instances, the laser emitter and detector banks 2220a, 2220b are electrically and/or communicatively coupled to the primary controller 320. In some embodiments, the laser emitter and detector banks 2220a, 2220b are electrically and/or communicatively coupled to the intermediate controller 322 rather than the primary controller 320. Further, the primary controller 320 is in communication with the fluid level sensor 166. In some forms, the primary controller 320 and the intermediate controller 322 are provided as a single, integrated controller.

The primary controller 320 determines a fluid level inside the vessel 102 (shown in FIG. 22) based on data and/or signals received from the fluid level sensor 166. The primary controller 320 also determines a height of the vessel 102 (e.g., a distance from the fluid level sensor 166 to the brim of the vessel 102) based on data and/or signals received from the intermediate controller 322, which are based on data and/or signals from the laser emitter and detector banks 2220a, 2220b. More specifically, in some instances, the intermediate controller 322 converts and/or reformats data from the laser emitter and detector banks 2220a, 2220b into data readable by the primary controller 320.

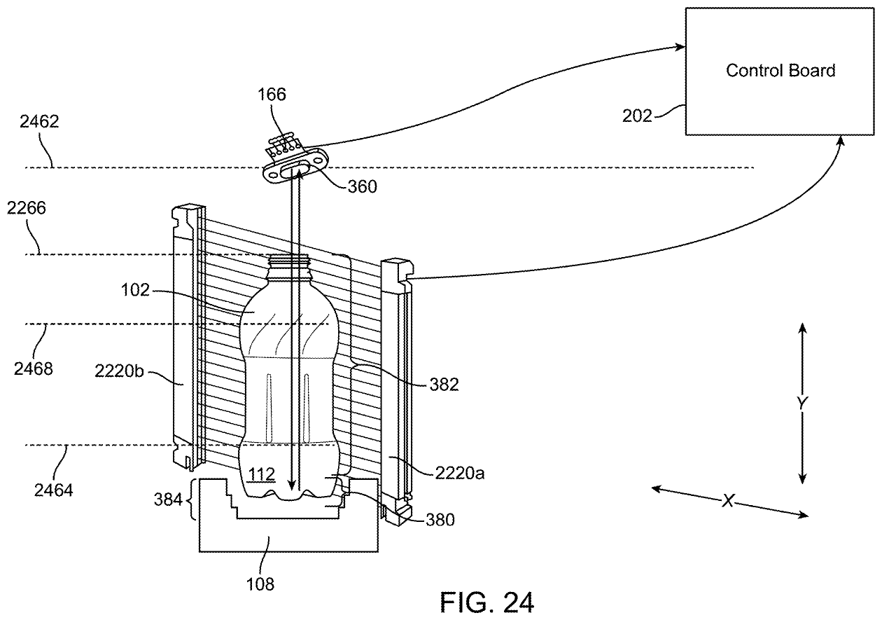

With reference to FIG. 24, the lower surface 360 of the fluid level sensor 166 and/or sensor housing 126 (shown in FIG. 7) defines a datum 2462 from which sensor measurements taken regarding the vessel 102 are relative. In operation, when the vessel 102 is placed in the vessel-centering fixture 108, the laser emitter and detector banks 2220a, 2220b detect the vessel 102 in the horizontal direction X and the fluid level sensor 166 detects the fluid 112 within the vessel 102 in a vertical direction Y.

The control board 202 determines an actual fluid level 2464 of the fluid 112 within the vessel 102 relative to the datum 2462 by way of one or both of the processors 342a, 342b based on data from the fluid level sensor 166. Further, the control board 202 determines the brim height 2266 of the vessel 102 relative to the datum 2462 by way of one or both of the processors 342a, 342b based on data from the laser emitter and detector banks 2220a, 2220b. Additionally, the control board 202 determines a target fluid level 2468 of the vessel 102 relative to the datum 2462 based on the brim height 2266 by way of one or both of the processors 342a, 342b. In some instances, a predefined offset distance value stored in one or more of the first and second memories 344a, 344b is used to calculate the target fluid level 2468. For example, a total vessel height can be calculated using a known distance from the bottom of the vessel-centering fixture 108 to the datum 2462 and the brim height 2266, e.g., the distance from the datum 2462 to the brim of the vessel 102. Then, a percentage of the total vessel height, such as 15 to 20 percent, can be added to the brim height 2266 to arrive at the target fluid level 2468. It should be understood that, instead of being subtracted, this percentage is added to the brim height 2266 because the fluid level sensor 166 senses (e.g., “looks”) downwardly. Thus, the target fluid level 2468 is further from the datum 2462 than the brim height 2266, e.g., the target fluid level 2468 is below the brim height 2266, so that the fluid dispenser 2200 does not overfill the vessel 102.

Additionally, in operation, the control board 202 controls the solenoid valve 182 and/or pump 304 (shown in FIG. 23) by way of one or both of the processors 342a, 342b to dispense the fluid 112 until the actual fluid level 2464 reaches the target fluid level 2468, at which point the control board 202 commands the solenoid valve 182 and/or pump 304 to stop dispensing the fluid 112 (e.g., close, turn off, etc.).

As explained above with respect to the fluid dispenser 100, when the vessel 102 is inserted into the vessel-centering fixture 108, the lower portion 380 of the vessel 102 can be obscured while the upper portion 382 remains exposed. Thus, in some instances, the lower portion 380 is hidden from, and the upper portion 382 is detectable by, the laser emitter and detector banks 2220a, 2220b. Further, in some instances, one or more of the first and second memories 344a, 344b store the predetermined depth 384 of the vessel-centering fixture 108 to compensate for the hidden lower portion 380 when determining the total vessel height of the vessel 102.

Further, in instances where a user mistakenly inserts a capped and/or closed vessel (not shown) into the vessel-centering fixture 108, the fluid level sensor 166 detects the closed vessel, and the control board 202 prevents dispensing of the fluid 112. Similarly, where a user prematurely removes the vessel 102 from the vessel-centering fixture 108 before dispensing of the fluid 112 is complete, the laser emitter and detector banks 2220a, 2220b detect the early removal, and the control board 202 stops dispensing the fluid 112.

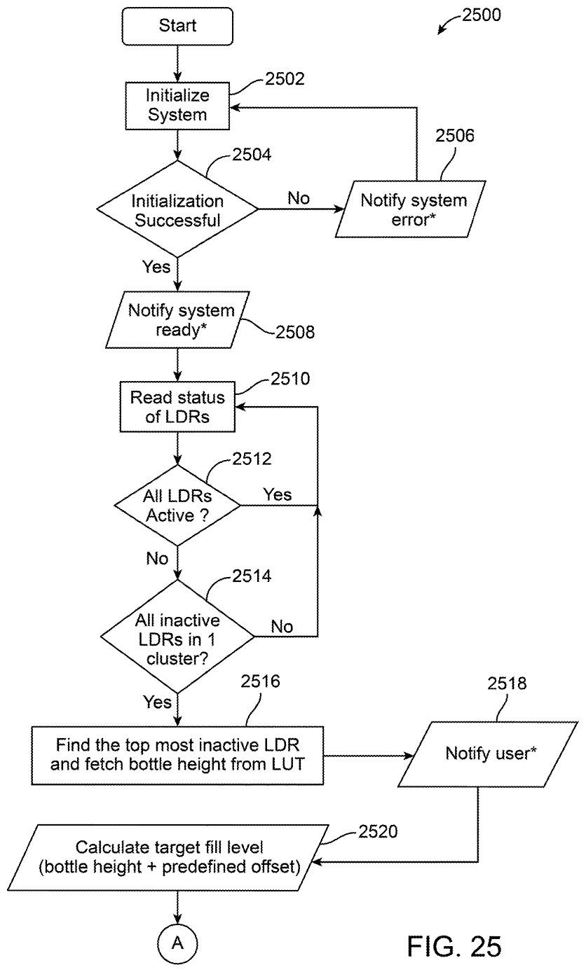

FIG. 25 illustrates a first portion of a flow diagram depicting a method 2500 executable by one or both of the processors 342a, 342b of the control board 202 (shown in FIG. 23) to dispense fluids using the fluid dispenser 2200 of FIG. 22. The method 2500 starts at step 2502, where the electronic components 2300 initialize and establish communications with one another. More specifically, the primary controller 320 and the intermediate controller 322 turn on via the power supply 302 and establish communications with one another. Further, the primary controller 320 establishes communications with the fluid level sensor 166 and, via the relay board 168 and the I/O expander 324, the solenoid valve 182 and the pump 304. Additionally, the intermediate controller 322 establishes communications with the laser emitter and detector banks 2220a, 2220b. Moreover, one or more of the first and second memories 344a, 344b populate a look-up table with the distance of each laser emitter from the datum 2462. The method 2500 proceeds to step 2504.

At step 2504, the control board 202 determines whether initialization was successful.

If, at step 2504, the control board 202 determines that initialization was not successful, the method proceeds to step 2506.

If, at step 2504, the control board 202 determines that initialization was successful, the method 2500 proceeds to step 2508.

At step 2506, the control board 202 notifies a user of the initialization failure (e.g., via a display, illuminated lamp, sound, etc.). In some forms, step 2506 is omitted. The method 2500 returns to step 2502.

At step 2508, the control board 202 notifies the user of the initialization success (e.g., via a display, illuminated lamp, sound, etc.). In some forms, step 2508 is omitted. The method 2500 proceeds to step 2510.

At step 2510, the primary controller 320 reads data from the intermediate controller 322 for a status of each individual laser detector in the laser detector bank 2220b. The primary controller 320 further parses and stores the laser detector statuses as a one-dimensional data string. The method 2500 proceeds to step 2512.

At step 2512, the control board 202 determines whether all the laser detectors in the laser detector bank 2220b are active.

If, at step 2512, the control board 202 determines that not all the laser detectors in the laser detector bank 2220b are active, the method 2500 proceeds to step 2514.

If, at step 2512, the control board 202 determines that all the laser detectors in the laser detector bank 2220b are active, thus signifying no vessel 102 is positioned in the fluid dispenser 2200, the method 2500 returns to step 2510.

At step 2514, the control board 202 determines whether all the inactive laser detectors in the laser detector bank 2220b are grouped into a continuous cluster (e.g., a user is holding the vessel 102 above the vessel-centering fixture 108 but below the highest laser in the laser detector bank 2220b).

If, at step 2514, the control board 202 determines that all the inactive laser detectors in the laser detector bank 2220b are grouped into a continuous cluster, the method 2500 proceeds to step 2516.

If, at step 2514, the control board 202 determines that all the inactive laser detectors in the laser detector bank 2220b are not grouped into a continuous cluster, the method 2500 returns to step 2510.

At step 2516, the control board 202 finds the top-most inactive laser detector and, using a brim height look-up table, determines the brim height 2266 of the vessel 102 relative to the datum 2462. More specifically, the primary controller 320 finds the index of the topmost inactive laser detector by referring to the data string. The method 2500 proceeds to step 2518.

At step 2518, the control board 202 notifies the user of the brim height 2266 (e.g., via a display, illuminated lamp, sound, etc.). In some forms, step 2518 is omitted. The method 2500 proceeds to step 2520.

At step 2520, the control board 202 calculates the target fluid level 2468. More specifically, the control board 202 adds the predefined offset distance value to the brim height 2266 to calculate the target fluid level 2468. The method 2500 proceeds to linking node A.

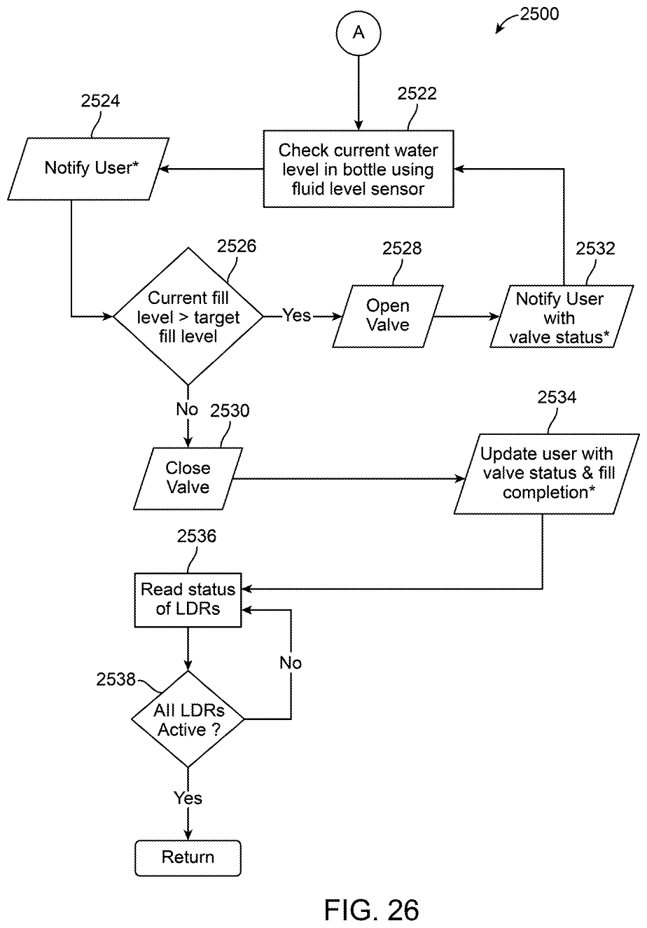

FIG. 26 illustrates a second portion of the flow diagram depicting the method 2500 executable by one or both of the processors 342a, 342b of the control board 202 (shown in FIG. 23) to dispense the fluid 112 using the fluid dispenser 2200 of FIG. 22. From linking node A, the method 2500 proceeds to step 2522, where the primary controller 320 checks the actual fluid level 2464 using the fluid level sensor 166. In some instances, one or both of the processors 342a, 342b averages a plurality of samples (e.g., ten samples) to determine the actual fluid level 2464. The method 2500 proceeds to step 2524.

At step 2524, the control board 202 notifies the user of the actual fluid level 2464 (e.g., via a display, illuminated lamp, sound, etc.). In some forms, step 2524 is omitted. The method 2500 proceeds to step 2526.

At step 2526, the control board 202 determines whether the actual fluid level 2464 is greater than the target fluid level 2468 with respect to the datum 2462.

If, at step 2526, the control board 202 determines that the actual fluid level 2464 is greater than the target fluid level 2468 with respect to the datum 2462, the method 2500 proceeds to step 2528.

If, at step 2526, the control board 202 determines that the actual fluid level 2464 is less than the target fluid level 2468 with respect to the datum 2462, the method 2500 proceeds to step 2530.

At step 2528, the control board 202 opens the solenoid valve 182 and/or initiates the pump 304. The method 2500 proceeds to step 2532.

At step 2532, the control board 202 notifies the user of a status (e.g., open, closed, etc.) of the solenoid valve 182 (e.g., via a display, illuminated lamp, sound, etc.). In some forms, step 2532 is omitted. The method 2500 returns to step 2522.

At step 2530, the control board 202 closes the solenoid valve 182 and/or deactivates the pump 304. The method 2500 proceeds to step 2534.

At step 2534, the control board 202 notifies the user of the status of the solenoid valve 182 and that the vessel 102 is full (e.g., via a display, illuminated lamp, sound, etc.). In some forms, step 2534 is omitted. The method 2500 proceeds to step 2536.

At step 2536, the primary controller 320 reads data from the intermediate controller 322 for a status of each individual laser detector in the laser detector bank 2220b. The primary controller 320 further parses and stores the laser detector statuses as a one-dimensional data string. The method 2500 proceeds to step 2538.

At step 2538, the control board 202 determines whether all the laser detectors in the laser detector bank 2220b are active.

If, at step 2538, the control board 202 determines that not all the laser detectors in the laser detector bank 2220b are active (signifying that the vessel 102 has not been removed), the method 2500 returns to step 2536.

If, at step 2538, the control board 202 determines that all the laser detectors in the laser detector bank 2220b are active (signifying removal of the vessel 102), the method 2500 returns to step 2502.

In other embodiments, other configurations are possible. For example, those of skill in the art will recognize, according to the principles and concepts disclosed herein, that various combinations, sub-combinations, and substitutions of the components discussed above can provide improved fluid-dispensing systems.

What is claimed is:

1. A fluid dispenser comprising:
a first sensor directed horizontally;
a second sensor directed vertically; and
a processor configured to
determine a brim height of a vessel based on data from the first sensor,
determine a target fill level based on the brim height,
determine a fluid level inside the vessel based on data from the second sensor, and
dispense fluid into the vessel until the fluid level reaches the target fill level.

2. The fluid dispenser of claim 1, wherein
the first sensor is supported in a vertical post of a frame, and
the second sensor is supported in a horizontal bridge of the frame.

3. The fluid dispenser of claim 1, wherein the second sensor is positioned above the vessel.

4. The fluid dispenser of claim 1, wherein the second sensor is positioned proximate to a fluid outlet of the fluid dispenser.

5. The fluid dispenser of claim 1, wherein the processor is supported in a hollow frame of the fluid dispenser.

6. The fluid dispenser of claim 1, wherein the processor is in communication with one or more of a valve and a pump to control dispensing of the fluid.

7. The fluid dispenser of claim 2, wherein the second sensor is positioned to sense downwardly from the horizontal bridge.

8. The fluid dispenser of claim 1, wherein a centering fixture aligns the vessel below the second sensor.

9. The fluid dispenser of claim 8, wherein
the centering fixture includes a plurality of vessel-centering actuators, and
each of the vessel-centering actuators is configured to urge the vessel to align with a vertical axis extending through the second sensor.

10. The fluid dispenser of claim 8, wherein the centering fixture defines a vessel cavity configured to receive the vessel.

11. The fluid dispenser of claim 1, wherein the second sensor is housed in a sensor housing extending downwardly from a horizontal bridge portion of a frame.

12. The fluid dispenser of claim 1, wherein the second sensor defines a horizontal datum relative to the vessel.

13. The fluid dispenser of claim 1, wherein
the target fill level is below the brim height, and
the target fill level is distanced from the brim height by a predetermined offset value.

14. The fluid dispenser of claim 1, further comprising a third sensor directed horizontally and positioned below the first sensor, wherein the processor is configured to determine the brim height of the vessel based on data from the first sensor and the third sensor.

15. The fluid dispenser of claim 1, wherein the first sensor includes a laser emitter opposite a laser detector.

16. A fluid dispenser comprising:
a frame including a bridge portion and a post;
a base connected to the post;
a fluid level sensor supported by the bridge portion;
a fluid outlet supported by the bridge portion proximate to the fluid level sensor;
a horizontal detection sensor supported by the post; and
a processor configured to cause the fluid dispenser to fill a vessel with a fluid dispensed from the fluid outlet to a target fluid level of the vessel based on data from the fluid level sensor and the horizontal detection sensor.

17. The fluid dispenser of claim 16, wherein
the processor is configured to determine a brim height of the vessel based on data from the horizontal detection sensor, and
the target fluid level is further from the fluid level sensor than the brim height.

18. The fluid dispenser of claim 16, wherein the processor is configured to
determine an actual fluid level of the fluid in the vessel based on data from the fluid level sensor, and
stop dispensing the fluid when the actual fluid level reaches the target fluid level.

19. A method of filling a vessel with a fluid, the method comprising:
placing the vessel into a fluid dispenser;
determining a brim height of the vessel with a first sensor;
determining an actual fluid level of the fluid within the vessel with a second sensor;
determining a target fill level based on the brim height and a predetermined offset value; and
dispensing the fluid into the vessel until the actual fluid level reaches the target fill level.

20. The method of claim 19, wherein placing the vessel in the fluid dispenser includes aligning the vessel relative to the second sensor with a vessel-centering fixture.
